(19) United States
(12) Patent Application Publication
(10) Pub. No.: US 2007/0163621 A1
(43) Pub. Date: Jul. 19, 2007

(54) Cleaning member for semiconductor apparatus and process for producing the same

(75) Inventors: Hitoshi Ishizaka, Ibaraki-shi (JP); Daisuke Uenda, Ibaraki-shi (JP); Daisuke Hanai, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: Nitto Denko Corporation, Osaka (JP)

(21) Appl. No.: 10/591,330

(22) PCT Filed: Mar. 7, 2005
(86) PCT No.: PCT/JP05/03874

§ 371 Date: Aug. 31, 2006

(30) Foreign Application Priority Data
Mar. 8, 2004 (JP) 2004-063858
Mar. 8, 2004 (JP) 2004-063859

(51) Int. Cl. B08B 9/00

(52) U.S. Cl. 134/22.1

(57) ABSTRACT

An object is to provide a cleaning member for semiconductor apparatus which can easily remove, without fail, foreign matters adherent to inner parts of a semiconductor apparatus, can bear a clearly readable mark for lot management, and can be prevented from generating particles upon contact with the holding part of a wafer case.

A cleaning member for semiconductor apparatus, characterized in that the cleaning member comprises a wafer 1 and formed on at least one side thereof a cleaning layer 2 made of a heat-resistant resin formed by thermally curing a poly(amic acid), and that the cleaning layer 2 has a part 12 where a wafer surface is exposed; and in particular a cleaning member for semiconductor apparatus having the constitution described above wherein that part 12 in the cleaning layer 2 in which a wafer surface is exposed is a part where the cleaning layer has been removed throughout the whole circular area having a given width ranging from the peripheral edge of the wafer toward the center thereof.

### TECHNICAL FIELD

The present invention relates to a cleaning member for semiconductor apparatus which is for use in removing foreign matters adherent to semiconductor production apparatus, semiconductor inspection equipments, or the like, and to a process for producing the cleaning member.

### BACKGROUND ART

In a substrate-processing apparatus, substrates are conveyed while being kept in physical contact with conveying systems by a vacuum holding mechanism, electrostatic attraction, or the like. In this operation, when a substrate or the conveying systems have foreign matters adherent thereto, the succeeding substrates are contaminated one after another. There has hence been a problem that it is necessary to periodically stop and clean the apparatus and this results in a reduced time efficiency and necessitates much labor.

Techniques for overcoming that problem have been proposed, which are a method in which a substrate having a tacky substance bonded thereto is conveyed in a substrate-processing apparatus to remove foreign matters adherent to inner parts of the apparatus (see patent document 1) and a method in which a platy member is conveyed to remove foreign matters adherent to the back side of a substrate (see patent document 2).

Patent Document 1: JP-A-10-154686

Patent Document 2: JP-A-11-87458

### DISCLOSURE OF THE INVENTION

### Problems to be Solved by the Invention

Those methods proposed are methods effective in avoiding a decrease in time efficiency and eliminating the necessity of much labor because there is no need of stopping the apparatus for conducting a cleaning treatment. However, the method in which a substrate having a tacky substance bonded thereto is conveyed has a drawback that the tacky substance tenaciously adheres to contact parts in the apparatus and it is hence difficult to smoothly convey the substrate in the apparatus. On the other hand, the method in which a platy member is conveyed is apt to be inferior in the ability to remove foreign matters.

The present applicant hence produced a cleaning member for semiconductor apparatus by forming a resinous coating layer comprising a polyimide resin as a cleaning layer on at least one side of a wafer (bare wafer), for the purpose of cleaning the wafer conveyor, chuck table for wafer fixing, etc. in a semiconductor apparatus such as a semiconductor production apparatus or inspection equipment. The applicant proposed a method in which this member is conveyed in a semiconductor apparatus to conduct the cleaning.

For applying a varnish for polyimide resin formation on a wafer in producing such a cleaning member for semiconductor apparatus, the technique of coating with a spin coater is advantageously employed in order to attain coating film evenness. In this coating technique, a varnish dropped onto a wafer is spread over the whole wafer surface by means of the centrifugal force generated by wafer rotation to thereby attain coating film evenness. In this case, however, the excess varnish is spilled out by centrifugal force and, hence, the utilization percentage of the resin material is generally as low as 10-20% by weight, resulting in a large material loss.

On the other hand, this cleaning member for semiconductor apparatus usually bears a laser-marked number for lot management thereof and this number plays an important role in ascertaining the lot of the cleaning member. Namely, this mark is automatically read with an image recognition apparatus such as a CCD camera and the lot number is analyzed and converted to a numerical value. The origin of the cleaning member is ascertained through these processings and the history thereof concerning cleaning treatment is recorded.

However, when this cleaning member is one in which a resinous coating layer has been formed as a cleaning layer over the whole surface on one or each side thereof, it has a drawback that the mark is covered with the resinous coating layer and the resin blocks light to make mark recognition difficult.

Furthermore, in the case where the resinous coating layer is formed over the whole surface of one or each side of a wafer, a phenomenon is apt to occur in which the resinous coating layer of the coated wafer which is in the state of being placed/stored in a wafer case comes into contact with the holding part (shelf) of the case and the resinous coating layer is abraded by friction due to the contact.

The fine resin particles thus formed by abrasion adhere to the surfaces of other cleaning members placed/stored in the wafer case. When these members are used, the particles are transferred to the handler for conveyance or chuck table for fixing of the semiconductor apparatus to be cleaned, resulting in particle contamination.

Under those circumstances, an object of the invention is to provide a cleaning member for semiconductor apparatus which can easily remove, without fail, foreign matters adherent to inner parts of a semiconductor apparatus, can bear a clearly readable mark for lot management, and can be prevented from generating particles upon contact with the holding part of a wafer case, by forming a specific resinous coating layer having a specific shape as a cleaning layer on at least one side of a wafer.

Another object of the invention is to provide, under the circumstances described above, a cleaning member for semiconductor apparatus which can be produced while avoiding a material loss in forming a resinous coating layer as a cleaning layer on at least one side of a wafer and which can easily remove, without fail, foreign matters adherent to inner parts of a semiconductor apparatus, can bear a clearly readable mark for lot management, and can be prevented from generating particles upon contact with the holding part of a wafer case.

### MEANS FOR SOLVING PROBLEMS

The present inventors made intensive investigations in order to accomplish those objects. As a result, they have found the following. By forming a specific resinous coating layer as a cleaning layer on at least one side of a wafer, foreign matters adherent to inner parts of a semiconductor apparatus can be easily removed without fail. Furthermore, by making the resinous coating layer have a part where a wafer surface is exposed, in particular by making the resinous coating layer have a part where the resinous coating layer has been removed throughout the whole circular area having a given width ranging from the peripheral edge of the wafer toward the center thereof, and by locating a mark for lot management in the part where a wafer surface is exposed, the mark can be clearly read. In addition, by placing this wafer in a wafer case so that the wafer-surface-exposed part comes into contact with the holding part of the wafer case, the holding part is prevented from coming into contact with the resinous coating layer and the resin particle generation caused by friction by the contact can be prevented. The invention has been completed based on these findings.

The inventors have further found the following. In forming the specific resinous coating layer, which is made of a heat-resistant resin formed by thermally curing a poly(amic acid), as a cleaning layer on at least one side of a wafer, use of a method in which a resin material is ejected from a coating nozzle disposed over the rotative wafer while horizontally moving the nozzle to thereby spirally apply the resin material to the wafer, in place of the spin coating in which a decrease in the utilization percentage of the resin material is unavoidable, is effective in preventing the utilization percentage of the resin material from decreasing and in considerably reducing a material loss.

Furthermore, the following have been found. By regulating the coating area in the wafer surface, in conducting the coating described above, so as to leave an uncoated part where a wafer surface is exposed, in particular to leave an uncoated part which is the whole circular area having a given width ranging from the peripheral edge of the wafer toward the center thereof, to thereby make the cleaning layer comprising the resultant resinous coating layer have a part where a wafer surface is exposed, and by locating a mark for lot management in the part where a wafer surface is exposed, the mark can be clearly read. In addition, by placing this wafer in a wafer case so that the wafer-surface-exposed part comes into contact with the holding part of the wafer case, the holding part is prevented from coming into contact with the resinous coating layer and the resin particle generation caused by friction by the contact can be prevented.

The invention has been completed based on those findings. The invention has the following constitutions.

1. A cleaning member for semiconductor apparatus, which comprises a wafer and formed on at least one side thereof a cleaning layer made of a heat-resistant resin formed by thermally curing a poly(amic acid), and wherein the cleaning layer has a part wherein a wafer surface is exposed.

2. The cleaning member for semiconductor apparatus according to the above 1, wherein that part in the cleaning layer in which a wafer surface is exposed is a part wherein the cleaning layer has been removed throughout the whole circular area having a given width ranging from the peripheral edge of the wafer toward the center thereof.

3. A process for producing a cleaning member for semiconductor apparatus, characterized by producing the cleaning member for semiconductor apparatus of the above 1. or 2. through:

a first step in which a varnish comprising a poly(amic acid) solution is produced;

a second step in which the varnish is applied to a wafer surface;

a third step in which the varnish applied on the wafer is dried;

a fourth step in which part of the varnish on the wafer is partly removed by dropping a solvent thereonto to thereby form a part wherein a wafer surface is exposed; and

a fifth step in which the residual coating film is cured at a temperature of 200° C. or higher.

4. A method of cleaning a semiconductor apparatus, characterized by conveying the cleaning member for semiconductor apparatus of the above 1. or 2. in the semiconductor apparatus to thereby remove foreign matters adherent to inner parts of the semiconductor apparatus.

5. A process for producing a cleaning member for semiconductor apparatus, which comprises a wafer and formed on at least one side thereof a cleaning layer made of a heat-resistant resin formed by thermally curing a poly(amic acid), and wherein the cleaning layer has a part where a wafer surface is exposed,

characterized by comprising:

(1) a step in which a varnish comprising a poly(amic acid) solution is obtained,
(2) a step in which the varnish is applied to a wafer,
(3) a step in which the varnish applied on the wafer is dried, and
(4) a step in which the coating film after the drying is cured at a temperature of 200° C. or higher,

wherein the step (2) comprises horizontally and rotatably fixing the wafer to the top of a table, disposing a horizontally movable coating nozzle over the wafer, ejecting the varnish from the nozzle while rotating the wafer and horizontally moving the nozzle to thereby spirally apply the varnish to the wafer so as not to leave a space between the spiral curves, and regulating that area in the wafer surface which is to be thus coated to thereby leave an uncoated part wherein a wafer surface is exposed.

6. The process for producing a cleaning member for semiconductor apparatus of the above 5, wherein the uncoated part wherein a wafer surface is exposed is the whole circular area having a given width ranging from the peripheral edge of the wafer toward the center thereof.

### EFFECT OF THE INVENTION

As described above, a cleaning layer in the invention is constituted of a specific resinous coating layer made of a heat-resistant resin formed by thermally curing a poly(amic acid) and part of the coating layer has been removed to form a part where a wafer surface is exposed. Because of this, a cleaning member can be provided in which a mark for lot management formed on the wafer has improved recognizability and which does not cause particle generation, i.e., dusting, when taken out of a wafer case, and can be used to stably conduct the cleaning of the wafer fixing table and conveying system of a semiconductor apparatus.

Furthermore, in the invention, a specific resinous coating layer made of a heat-resistant resin formed by thermally curing a poly(amic acid) is formed as a cleaning layer by a specific technique in which a varnish is spirally applied to a wafer. Because of this, the material loss accompanying the spin coating method is eliminated and the resin material can be utilized while avoiding a waste of it. In addition, since the cleaning layer comprising this resinous coating layer is formed so as to have a part where a wafer surface is exposed, a cleaning member can be provided in which a mark for lot management formed on the wafer has improved visibility and which does not cause particle generation, i.e., dusting, when taken out of a wafer case, and can be used to stably conduct the cleaning of the wafer fixing table and conveying system of a semiconductor apparatus.

Moreover, since the cleaning layer described above which has a part where a wafer surface is exposed is formed by a method in which the coating area in wafer coating is regulated so as to leave an uncoated part, the formation of an exposed part is easier than in other methods, e.g., the method in which the whole wafer surface is coated and part of the coating is thereafter dissolved away to form a part where a wafer surface is exposed. Thus, a process for cleaning member production which is more desirable from the standpoint of steps can be provided.

### BRIEF DESCRIPTION OF THE DRAWINGS

FIG. 1 shows one embodiment of the cleaning member for semiconductor apparatus of the invention; (A) is a sectional view and (B) is a plan view.

FIG. 2 is a sectional view illustrating another embodiment of the cleaning member for semiconductor apparatus of the invention.

FIG. 3 is a sectional view illustrating still another embodiment of the cleaning member for semiconductor apparatus of the invention.

FIG. 4 is a sectional view illustrating the state in which a wafer is rotatably fixed to the top of a vacuum holding table in a process of the invention for producing a cleaning member for semiconductor apparatus.

FIG. 5 is a sectional view illustrating the state in which a varnish is dropped onto the wafer with a spin coater in the process of the invention for producing a cleaning member for semiconductor apparatus.

FIG. 6 is a sectional view illustrating the state in which the wafer is rotated to apply the varnish to the whole wafer surface in the process of the invention for producing a cleaning member for semiconductor apparatus.

FIG. 7 is a sectional view illustrating the state in which a protruding part of the varnish is treated with a rinse to make the varnish surface flat in the process of the invention for producing a cleaning member for semiconductor apparatus.

FIG. 8 is a sectional view illustrating the state in which a varnish is applied to a wafer with a nozzle coater in a process of the invention for producing a cleaning member for semiconductor apparatus.

### DESCRIPTION OF REFERENCE NUMERALS

1 silicon wafer
2, 3 cleaning layer
12, 13 part where wafer surface is exposed
4 vacuum holding table
5 rotating shaft
6 dispenser for varnish application
7 varnish
8 protruding part
9 nozzle for edge rinsing
10 rinse
16 coating nozzle

### BEST MODE FOR CARRYING OUT THE INVENTION

Embodiments of the invention will be explained below by reference to the drawings of the invention.

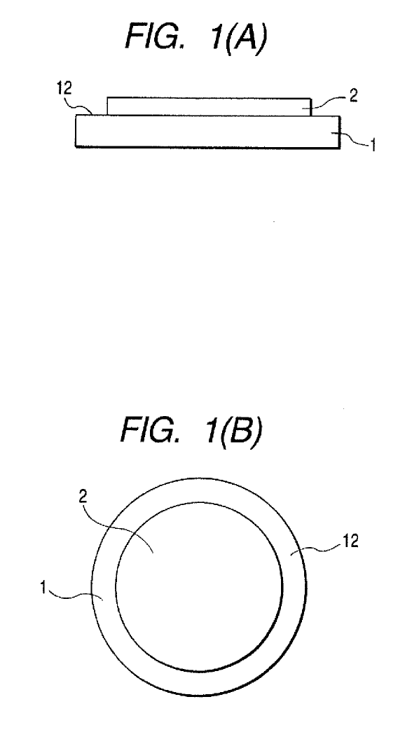

FIG. 1 shows one embodiment of the cleaning member for semiconductor apparatus of the invention; (A) is a sectional view and (B) is a plan view.

In FIG. 1, 1 denotes a wafer (bare wafer) and 2 denotes a cleaning layer formed on one side of the wafer 1 and made of a heat-resistant resin formed by thermally curing a poly(amic acid). This cleaning layer has a part 12 where a wafer surface is exposed. This exposed part 12 is a part where the cleaning layer has been removed throughout the whole circular area having a given width ranging from the peripheral edge of the wafer toward the center thereof. The wafer surface in this exposed part 12 bears a mark for lot management (not shown) which has been formed beforehand by laser marking.

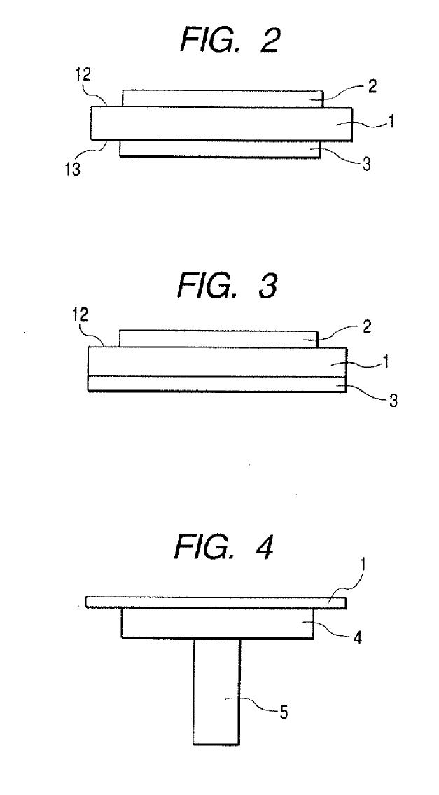

FIG. 2 shows another embodiment of the cleaning member for semiconductor apparatus of the invention. This embodiment has a constitution which comprises a wafer 1 and, formed respectively on both sides thereof, cleaning layers 2 and 3 made of a heat-resistant resin formed by thermally curing a poly(amic acid) and in which the two cleaning layers 2 and 3 have parts 12 and 13 where a wafer surface is exposed as in the case shown in FIG. 1.

Incidentally, this cleaning member may have only either of the exposed parts 12 and 13. For example, the cleaning member may have a constitution in which only the cleaning layer 2 has an exposed part 12 and the cleaning layer 3 does not have an exposed part 13.

FIG. 3 shows still another embodiment of the cleaning member for semiconductor apparatus of the invention. This embodiment comprises a wafer 1 and, formed respectively on both sides thereof, cleaning layers 2 and 3 made of a heat-resistant resin formed by thermally curing a poly(amic acid), as in the case shown in FIG. 2. However, this cleaning member has a constitution in which only the cleaning layer 2 has a part 12 where a wafer surface is exposed as in the case shown in FIG. 1 and the cleaning layer 3 does not have such a part wherein a wafer surface is exposed.

In the cleaning members for semiconductor apparatus shown in FIG. 1 to FIG. 3, the cleaning layers 2 (3) are constituted of a specific resinous coating layer made of a heat-resistant resin formed by thermally curing a poly(amic acid). Because of this, by conveying any of these cleaning members in a semiconductor apparatus, foreign matters adherent to inner parts of the semiconductor apparatus, such as, e.g., foreign matters adherent to the wafer conveyor, chuck table for wafer fixing, or the like, can be satisfactorily removed with the cleaning layer 2. Furthermore, since the cleaning layer 2 (3) has a part 12 (13) where a wafer surface is exposed, the mark for lot management which has been formed beforehand in this part by laser marking can be clearly read. Thus, the origin of the cleaning member can be ascertained and the history thereof concerning cleaning treatment can be recorded/managed.

In addition, when this cleaning member for semiconductor apparatus is placed/stored in a wafer case, it is placed so that the part 12 (13) where a wafer surface is exposed is brought into contact with the holding part of the wafer case. Thus, the holding part can be prevented from coming into contact with the resinous coating layer which is the cleaning layer 2 (3). The resin particle generation, i.e., dusting, caused by friction by the contact can hence be prevented. As a result, the secondary contamination in which particles are transferred to the handler for conveyance or chuck table for fixing of the semiconductor apparatus can be prevented.

In FIG. 1 and FIG. 2 described above, the part 12 (13) where a wafer surface is exposed is constituted of the whole circular area which has no cleaning layer and has a given width ranging from the peripheral edge of the wafer toward the center thereof. However, the part 12 (13) where a wafer surface is exposed is not limited to this constitution, and a part where a wafer surface is exposed can be formed in a suitable position in the wafer according to the position of the laser mark for lot management or to the position of the holding part of a wafer case for placement/storage.

Next, a process for producing the cleaning member for semiconductor apparatus which has any of the constitutions described above is explained. This process essentially comprises: a first step in which a varnish comprising a poly(amic acid) solution is produced; a second step in which the varnish is applied to a wafer surface; a third step in which the varnish applied on the wafer is dried; a fourth step in which part of the varnish on the wafer is partly removed by dropping a solvent thereonto to thereby form a part where a wafer surface is exposed; and a fifth step in which the residual coating film is cured at a temperature of 200° C. or higher.

In the first step, the varnish comprising a poly(amic acid) can be produced by a known method. For example, a tetracarboxylic acid dianhydride, trimellitic anhydride, or a derivative of either is subjected to condensation reaction with a diamine compound in a suitable organic solvent, e.g., N-methyl-2-pyrrolidone, N,N-dimethylacetamide, or N,N-dimethylformamide, whereby the varnish can be produced as a solution of an imide precursor.

Examples of the tetracarboxylic acid dianhydride include 3,3′,4,4′-biphenyltetracarboxylic acid dianhydride, 2,2′,3,3′-biphenyltetracarboxylic acid dianhydride, 3,3′,4,4′-benzophenonetetracarboxylic acid dianhydride, 2,2′,3,3′-benzophenonetetracarboxylic acid dianhydride, 4,4′-hydroxydiphthalic acid dianhydride, 2,2-bis(2,3-dicarboxyphenyl)hexafluoropropane dianhydride, 2,2-bis(3,4-dicarboxyphenyl)hexafluoropropane dianhydride (6FDA), bis(2,3-dicarboxyphenyl)methane dianhydride, bis(3,4-dicarboxyphenyl)methane dianhydride, bis(2,3-dicarboxyphenyl) sulfone dianhydride, bis(3,4-dicarboxyphenyl) sulfone dianhydride, pyromellitic dianhydride, and ethylene glycol bistrimellitate dianhydride. These may be used alone or in combination of two or more thereof.

Examples of the diamine compound include ethylenediamine, hexamethylenediamine, 1,10-diaminodecane, 4,9-dioxa-1,12-diaminododecane, 4,4′-diaminodiphenyl ether, 3,4′-diaminodiphenyl ether, 3,3′-diaminodiphenyl ether, m-phenylenediamine, p-phenylenediamine, 4,4′-diaminodiphenylpropane, 3,3′-diaminodiphenylpropane, 4,4′-diaminodiphenylmethane, 3,3′-diaminodiphenylmethane, 4,4′-diaminodiphenyl sulfide, 3,3′-diaminodiphenyl sulfide, 4,4′-diaminodiphenyl sulfone, 3,3′-diaminodiphenyl sulfone, 1,4-bis(4-aminophenoxy)benzene, 1,3-bis(4-aminophenoxy)benzene, 1,3-bis(3-aminophenoxy)benzene, 1,3-bis(4-aminophenoxy)-2,2-dimethylpropane, hexamethylenediamine, 1,8-diaminooctane, 1,12-diaminododecane, 4,4′-diaminobenzophenone, and 1,3-bis(3-aminopropyl)-1,1,3,3-tetramethyldisiloxane.

In the second step, the varnish is applied to a wafer surface. For this application, use may be made of any coating technique capable of attaining an even film thickness. For example, spin coating, spray coating, die coating, deposition polymerization by the vacuum deposition method, or the like can be used.

Especially preferred of these is spin coating. This spin coating is explained below in detail by reference to FIG. 4 to FIG. 7.

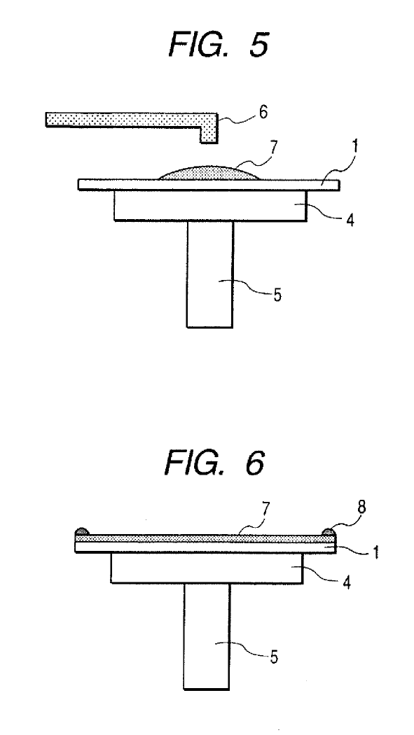

First, as shown in FIG. 4, a wafer 1 (bare wafer) is rotatably fixed to the top of a vacuum holding table 4 connected to a rotating shaft 5. Subsequently, the varnish 7 is dropped onto a central part of the wafer 1 from a dispenser 6 of the spin coater as shown in FIG. 5.

The viscosity of the varnish to be dropped can be selected in the range of 10-10,000 mPa·sec. However, the viscosity thereof is preferably regulated so as to be in the range of 500-3,000 mPa·sec from the standpoint of obtaining a film thickness at which dust-removing properties (foreign-matter-removing properties) can be secured.

After the dropping, the wafer is rotated at a high speed. The speed of this rotation is desirably selected generally in the range of 500-2,000 rpm, especially preferably in the range of 900-1,500 rpm. The time period required for the rotation speed to reach this set value also considerably influences the evenness of film thickness. It is therefore desirable to increase the rotation speed to the set value at an acceleration of 5,000 rpm/sec or higher, especially preferably at an acceleration of 10,000 rpm/sec or higher.

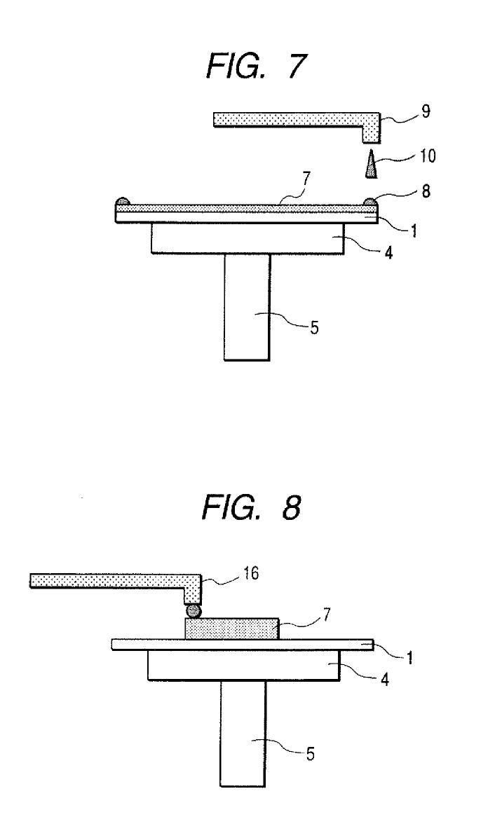

Through this spin coating, a coating film of the varnish 7 is formed on the whole surface of one side of the wafer 1 as shown in FIG. 6. In this operation, however, a varnish-protruding part 8 is formed along the peripheral edge of the wafer. The same organic solvent as that used for the varnish 7, e.g., N-methyl-2-pyrrolidone, is dropped as a rinse 10 onto the protruding part 8 from a nozzle 9 for edge rinsing as shown in FIG. 7. Thus, edge rinsing for dissolving the protruding part 8 is conducted to make the coating film flat.

Thus, a coating film of the varnish 7 is formed in an even thickness on the whole surface of one side of the wafer 1. This thickness is desirably regulated so that the cleaning layer 2 finally formed through the third step (drying step) to the fifth step (imidization step) has a thickness in the range of 1-300 μm. From the standpoint of evenness of film thickness, smaller thicknesses are preferred. From the standpoint of dust-removing properties, larger film thicknesses are preferred because of satisfactory conformability to recesses and protrusions. When a balance between these is taken into account, it is especially desirable to regulate the coating film thickness so that the final cleaning layer 2 has a thickness in the range of 10-100 μm.

In the third step, the varnish coating film thus formed is dried. This drying is conducted in order to harden the coating fluid, which is a fluid, so as to inhibit fluid flowing during handling in the succeeding steps. For this drying step, it is preferred to select conditions under which most of the solvent ingredient in the varnish is removed. Generally, a temperature in the range of 70-150° C. can be used. From the standpoint of preventing film deterioration, lower temperatures are preferred. From the standpoint of the efficiency of removing the solvent ingredient, higher temperatures are preferred. When a balance between these is taken into account, it is especially desirable to set the temperature at 90-100° C.

In the fourth step, a solvent is dropped onto the varnish coating film after the drying to remove part of the varnish and thereby form a part where a wafer surface is exposed. Specifically, that part of the varnish coating film which corresponds to the whole circular area having a given width ranging from the peripheral edge of the wafer toward the center thereof is removed to form the part where a wafer surface is exposed.

This method is essentially the same as the edge rinsing method used in the second step for dissolving the varnish-protruding part for flattening. Namely, after the flattening and drying, the same organic solvent as that used for the varnish, e.g., N-methyl-2-pyrrolidone, is dropped again as a rinse from the nozzle for edge rinsing to further dissolve away the flattened coating film and thereby expose a surface of the underlying wafer.

The position in which the organic solvent as a rinse is to be dropped can be regulated with an actuator employing a ball screw. The position is regulated with an accuracy of ±100 μm. The coating film is thus dissolved away, whereby the region of the part where the wafer is exposed can be determined. Preferably, the position is regulated with an accuracy of ±10 μm, whereby the width of the region can be regulated more precisely.

It is important that the dropping position be scanned outward from an inner part at a constant speed. By the scanning, even an exposed area extending over a wide region can be formed. In the case where outward scanning is conducted, it is improper to scan to the outermost peripheral edge, and it is desirable to stop the scanning at a position 3 mm apart from the notched edge present on the wafer. This is because the rinse splashes at the notch and is scattered up to a central part and this rinse scattered causes dissolution even in the central part, which is desired to retain flatness, resulting in small depressions and hence in impaired dust-removing performance.

In the fifth step, after the part where a wafer surface is exposed has been thus formed, the coating film is cured and imidized at a temperature of 200° C. or higher. Thus, a resinous coating layer is formed which is constituted of a heat-resistant resin comprising a polyimide resin (poly(amide-imide) resin), an imide precursor thereof (resin partly remaining unimidized), or the like according to the material constituting the varnish.

The curing temperature for imidization varies depending on the material constituting the varnish. The profile thereof also varies. In general, however, heating is preferably conducted from ordinary temperature at about 3° C./min and the maximum curing temperature is desirably 200° C. or higher. The holding time is set according to properties of the material. For preventing film properties from deteriorating, it is desirable to conduct the curing in a nitrogen atmosphere. The concentration of oxygen is desirably set at 100 ppm or lower. By reducing the oxygen concentration preferably to 20 ppm, a resinous coating layer having satisfactory properties is obtained.

Another process for producing the cleaning member for semiconductor apparatus is explained below as another embodiment of the invention. This production process essentially comprises (1) a step in which a varnish comprising a poly(amic acid) solution is obtained, (2) a step in which the varnish is applied to a wafer, (3) a step in which the varnish applied on the wafer is dried, and (4) a step in which the coating film after the drying is cured at a temperature of 200° C. or higher.

In step (1), the varnish comprising a poly(amic acid) is produced by a known method. For example, a tetracarboxylic acid dianhydride, trimellitic anhydride, or a derivative of either is subjected to condensation reaction with a diamine compound in a suitable organic solvent, e.g., N-methyl-2-pyrrolidone, N,N-dimethylacetamide, or N,N-dimethylformamide, whereby the varnish is produced as a solution of an imide precursor.

Examples of the tetracarboxylic acid dianhydride include 3,3′,4,4′-biphenyltetracarboxylic acid dianhydride, 2,2′,3,3′-biphenyltetracarboxylic acid dianhydride, 3,3′,4,4′-benzophenonetetracarboxylic acid dianhydride, 2,2′,3,3′-benzophenonetetracarboxylic acid dianhydride, 4,4′-hydroxydiphthalic acid dianhydride, 2,2-bis(2,3-dicarboxyphenyl)hexafluoropropane dianhydride, 2,2-bis(3,4-dicarboxyphenyl)hexafluoropropane dianhydride (6FDA), bis(2,3-dicarboxyphenyl)methane dianhydride, bis(3,4-dicarboxyphenyl)methane dianhydride, bis(2,3-dicarboxyphenyl) sulfone dianhydride, bis(3,4-dicarboxyphenyl) sulfone dianhydride, pyromellitic dianhydride, and ethylene glycol bistrimellitate dianhydride. These may be used alone or in combination of two or more thereof.

Examples of the diamine compound include ethylenediamine, hexamethylenediamine, 1,10-diaminodecane, 4,9-dioxa-1,12-diaminododecane, 4,4′-diaminodiphenyl ether, 3,4′-diaminodiphenyl ether, 3,3′-diaminodiphenyl ether, m-phenylenediamine, p-phenylenediamine, 4,4′-diaminodiphenylpropane, 3,3′-diaminodiphenylpropane, 4,4′-diaminodiphenylmethane, 3,3′-diaminodiphenylmethane, 4,4′-diaminodiphenyl sulfide, 3,3′-diaminodiphenyl sulfide, 4,4′-diaminodiphenyl sulfone, 3,3′-diaminodiphenyl sulfone, 1,4-bis(4-aminophenoxy)benzene, 1,3-bis(4-aminophenoxy)benzene, 1,3-bis(3-aminophenoxy)benzene, 1,3-bis(4-aminophenoxy)-2,2-dimethylpropane, hexamethylenediamine, 1,8-diaminooctane, 1,12-diaminododecane, 4,4′-diaminobenzophenone, and 1,3-bis(3-aminopropyl)-1,1,3,3-tetramethyldisiloxane.

In step (2), the varnish is applied to a wafer with a nozzle coater. This coating step is an especially important step in the invention. It attains an improved utilization percentage of the resin material as compared with the spin coating method and is effective in attaining a considerable reduction in material loss.

First, as shown in FIG. 4, a wafer 1 is horizontally and rotatably fixed to the top of a vacuum holding table 4 connected to a rotating shaft 5. Subsequently, as shown in FIG. 8, a horizontally movable coating nozzle 16 is disposed over the wafer 1 and the gap between this nozzle 16 and the wafer 1 is regulated. Thereafter, the varnish 7 is ejected from the nozzle 16 while rotating the wafer 1 at an appropriate rotation speed and horizontally moving the nozzle 16 to thereby spirally apply the varnish 7 to the wafer 1 so as not to leave a space between the spiral curves (so as to cause the ejected varnish to slightly overlap).

In this application, the horizontal movement of the nozzle 16 may be conducted in such a manner that the nozzle 16 is moved from the center toward the circumference or, conversely, is moved from a peripheral part to the center. Furthermore, in thus conducting application, the position in which the nozzle 16 is moved over the wafer 1 is regulated or the position in which the varnish 7 is ejected (ejection initiation position or ejection termination position) is regulated, whereby that area in the surface of the wafer 1 which is to be coated is regulated to thereby leave an uncoated part where a wafer surface is exposed.

Specifically, in the case where the nozzle 16 is horizontally moved from the center toward the circumference, the ejection of the varnish 7 is stopped when the nozzle 16 has reached a position inward apart from the wafer periphery at a given distance. Thus, an uncoated part is left which is the whole circular area having a given width ranging from the peripheral edge of the wafer toward the center thereof.

The viscosity of the varnish to be applied in the coating step described above can be selected in the range of 100-10,000 mPa·sec. However, the viscosity thereof is preferably regulated so as to be in the range of 300-3,000 mPa·sec from the standpoint of obtaining a film thickness at which dust-removing properties (foreign-matter-removing properties) can be secured. The coating thickness is desirably regulated so that the cleaning layer finally formed through the succeeding steps (3) and (4) has a thickness of 10-300 μm. From the standpoint of evenness of film thickness, smaller thicknesses are preferred. From the standpoint of dust-removing properties, larger film thicknesses are preferred because of satisfactory conformability to recesses and protrusions. When a balance between these is taken into account, it is especially desirable to regulate the coating thickness so that the final cleaning layer has a thickness in the range of 10-200 μm.

In step (3), the varnish 7 thus applied on the wafer 1 is dried. This drying is conducted in order to harden the coating fluid, which is a fluid, so as to inhibit fluid flowing during handling in the succeeding step. For this drying step, it is preferred to select conditions under which most of the solvent ingredient in the varnish is removed. Generally, a temperature in the range of 70-150° C. can be used. From the standpoint of preventing film deterioration, lower temperatures are preferred. From the standpoint of the efficiency of removing the solvent ingredient, higher temperatures are preferred. When a balance between these is taken into account, it is especially desirable to set the temperature at 90-100° C.

In step (4), the coating film from which the solvent ingredient has been removed as described above is cured and imidized at a temperature of 200° C. or higher. Thus, a resinous coating layer is formed which is constituted of a heat-resistant resin comprising a polyimide resin (poly(amide-imide) resin), an imide precursor thereof (resin partly remaining unimidized), or the like according to the material constituting the varnish.

The curing temperature for imidization varies depending on the material constituting the varnish. The profile thereof also varies. In general, however, heating is preferably conducted from ordinary temperature at about 3° C./min and the maximum curing temperature is desirably 200° C. or higher. The holding time is set according to properties of the material. For preventing film properties from deteriorating, it is desirable to conduct the curing in a nitrogen atmosphere. The concentration of oxygen is desirably set at 100 ppm or lower. By reducing the oxygen concentration preferably to 20 ppm, a resinous coating layer having satisfactory properties is obtained.

Through steps (1) to (4) described above, a cleaning layer constituted of a resinous coating layer made of a heat-resistant resin obtained by thermally curing a poly(amic acid) is formed on the wafer. Thus, a cleaning member for semiconductor apparatus is obtained in which this cleaning layer has a part where a wafer surface is exposed and, in particular, this exposed part is the whole circular area which is not coated with the cleaning layer and has a given width ranging from the peripheral edge of the wafer toward the center thereof.

According to the production process described above, the utilization percentage of the resin material is improved and a considerable reduction in material loss can be attained as compared with the spin coating method, because the specific nozzle coating method described above in the coating step (2) is employed. In addition, since that area in the wafer surface which is to be coated is regulated in the coating step to thereby leave an uncoated part, there is no need of additionally conducting a step for thereafter forming a part where a wafer surface is exposed. This process is hence advantageous from the standpoint of production steps.

After the steps described above, the coated wafer may be further subjected to necessary steps by ordinary methods. Thus, a cleaning member having a cleaning layer comprising the resinous coating layer is produced.

There are cases where this cleaning member has fine particles adherent to the back side thereof because of the steps described above and these particles may cause contamination. In view of the intended use of the cleaning member, it is necessary to remove such fine particles beforehand. The contamination is thought to include transfer from the chuck table in each step. In particular, the fine particles transferred from the vacuum holding table more tenaciously adhere to the back side of the wafer because of the vacuum holding force as an external force. These fine particles have deeply bitten into the SiO₂ and cannot be easily removed.

Examples of cleaning methods for removing such fine particles tenaciously adherent to the back side include spin cleaning in which a detergent is sprinkled on a wafer kept being rotated and dip cleaning in which two or more wafers are simultaneously immersed in a liquid chemical. In the spin cleaning, physical cleaning such as one with a brush, two fluids, ultrasonic called megasonic, or the like can be effectively conducted additionally.

In chemical liquid cleaning conducted in combination with physical cleaning, it is effective to employ an alternating treatment with ozonized water and dilute hydrofluoric acid. Those parts of the SiO₂ which surround the fine particles which have bitten are removed with the dilute hydrofluoric acid, in which SiO₂ is soluble, and the oxidized surface of the fine particles is dissolved away with the ozonized water, whereby the fine particles can be separated from the wafer surface.

By repeatedly conducting such treatments, slight metallic contaminants adherent to the SiO₂ surface can be removed simultaneously with the fine particles. It is generally said that in semiconductor processes, metal atoms should be diminished to below 1.0×10⁻¹⁰ atoms/cm² for producing a satisfactory semiconductor element. With respect to the cleaning member of the invention also, it is desirable to add cleaning with dilute hydrofluoric acid in order to clear that standard.

In the brush cleaning, the brush itself is gradually contaminated with repetitions of the cleaning and, hence, it is necessary to periodically conduct brush cleaning. For preventing re-contamination caused by the brush, it is effective to use megasonic in combination with hydrogenous water prepared by dissolving hydrogen gas in ultrapure water. This hydrogenous water is desirably regulated so as to have a pH of 9.0 or higher, whereby fine particles can be prevented from re-adhering based on electrostatic repulsion (zeta-potential).

### EXAMPLES

The invention will be explained below in more detail by reference to Examples. However, the invention should not be construed as being limited to the following Examples only.

### Example 1

In a nitrogen stream, 30.0 g of ethylene-1,2-bistrimellitate tetracarboxylic dianhydride represented by the following chemical structural formula (hereinafter referred to as TMEG) was mixed and reacted with 65.8 g of a diamine (trade name “1300x16ATBN” manufactured by Ube Industries, Ltd.) and 15.0 g of 2,2′-bis[4-(4-aminophenoxy)phenyl]propane represented by the following chemical structural formula (hereinafter referred to as BAPP) at 120° C. in 110 g of N-methyl-2-pyrrolidone (hereinafter referred to as NMP).

[Ka-1]

### Ethylene-1,2-bistrimellitate tetracarboxylic dianhydride

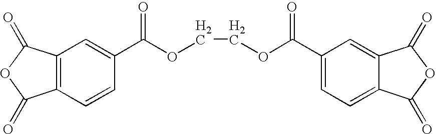

### 2,2′-Bis[4-(4-aminophenoxy)phenyl]propane

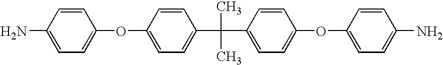

After the reaction, the reaction mixture was cooled to obtain a varnish comprising a poly(amic acid) solution. This varnish was applied to one side of a 12-inch silicon wafer with a spin coater. In this application, the rotation speed was increased to 1,000 rpm at an acceleration of 10,000 rpm/sec, which took about 0.1 second. Thereafter, that rotation speed was maintained until 0.5 seconds had passed since the initiation of the rotation. The rotation speed was then reduced to 500 rpm at a decelation of 100 rpm/sec, and this rotation speed was maintained for 40 seconds.

Next, the nozzle position was automatically controlled, and NMP was dropped onto the protruding part which had formed along the periphery to thereby conduct edge rinsing and flattening. Thereafter, the coating film was dried at 90° C. for 20 minutes.

Subsequently, the wafer was set in the spin coater again. The nozzle position was automatically controlled in the same manner as in the edge rinsing, and the nozzle was scanned from the center side toward the periphery only over a desired width to dissolve away part of the resin applied and thereby expose a wafer surface. Namely, only that part of the resin applied which corresponded to the whole circular area having a given width ranging from the peripheral edge of the wafer toward the center thereof was removed by dissolution to form a part where a wafer surface was exposed. This exposed part had a width of 6 mm. It was ascertained that the mark formed near the wafer periphery was sufficiently exposed in that region.

Thereafter, the wafer was heated at 300° C. for 2 hours in a nitrogen atmosphere to form a polyimide resin film having a thickness of 10 μm. Thus, a cleaning member having the structure shown in FIG. 1 was produced which was composed of a 12-inch silicon wafer and formed on one side thereof a cleaning layer comprising the polyimide resin film and in which a wafer surface was exposed in a peripheral part of the wafer.

The cleaning member thus produced was evaluated for dust-removing properties (foreign-matter-removing properties), suitability for conveyance, and mark recognizability. In this evaluation, dust-removing properties were judged based on the count of aluminum pieces, and suitability for conveyance was judged based on whether the cleaning member was capable of being separated from a vacuum holding table with a lifting pin. Furthermore, mark recognizability was judged based on whether the mark observed through an examination with a CCD camera and image processing was correct.

The evaluation of dust-removing properties and suitability for conveyance was conducted in the following manner.

Twenty aluminum pieces 1 mm square were placed on the vacuum holding table of a semiconductor production apparatus. The cleaning member was placed thereon so that the resin-coated side thereof came into contact with these aluminum pieces. Vacuum suction (0.5 kg/cm²) was conducted for about 10 seconds, and it was attempted to separate the wafer from the table with a lifting pin. As a result, the wafer could be easily taken out. Thereafter, the number of aluminum pieces removed from the table was visually counted. As a result, the cleaning member was ascertained to show a degree of dust removal of 90% or higher in each of three counting operations.

In the evaluation of mark recognizability, a diffuser which diffused LED light was used and a CCD camera was disposed so that the shape of the mark could be caught by the CCD camera in a dark field. An image from the CCD camera was processed with a character recognition apparatus to ascertain whether the mark could be correctly recognized. As a result, the mark exposed could be correctly read as in the recognition of marks on ordinary bare wafers.

### Example 2

Both sides of a 12-inch silicon wafer were subjected to the same treatment as in Example 1. Thus, a cleaning member having the structure shown in FIG. 2 was produced which was composed of the wafer and formed on each side thereof a cleaning layer comprising a polyimide resin film having a thickness of 10 μm and in which a wafer surface was exposed in a wafer peripheral part (exposure width: 6 mm) for each of the two cleaning layers.

This cleaning member was evaluated for dust-removing properties, suitability for conveyance, and mark recognizability in the same manners as in Example 1. As a result, the wafer could be easily taken out by wafer separation with a lifting pin. It was further ascertained that in the visual counting of the number of aluminum pieces removed from the table, the cleaning member showed a degree of dust removal of 90% or higher in each of three counting operations. Furthermore, as a result of the processing of an image from the CCD camera with a character recognition apparatus, the mark exposed could be correctly read as in the recognition of marks on ordinary bare wafers.

### Comparative Example 1

One side of a 12-inch silicon wafer was subjected to application of a varnish comprising a poly(amic acid) solution with a spin coater, flattening by edge rinsing, and thermal drying at 90° C. in the same manner as in Example 1. Thereafter, the coated wafer was subjected to a heat treatment at 300° C. without being subjected to the treatment for partly dissolving the applied resin in order to expose a wafer surface. Thus, a cleaning member was produced which was composed of the wafer and, formed over the whole surface of one side thereof, a cleaning layer comprising a polyimide resin film having a thickness of 10 μm.

This cleaning member was evaluated for dust-removing properties, suitability for conveyance, and mark recognizability in the same manners as in Example 1. As a result, the wafer could be easily taken out by wafer separation with a lifting pin. It was further ascertained that in the visual counting of the number of aluminum pieces removed from the table, the cleaning member showed a degree of dust removal of 90% or higher in each of three counting operations. However, as a result of the processing of an image from the CCD camera with a character recognition apparatus, the mark underlying the cleaning layer could not be correctly recognized because of the impaired transparency due to the overlying cleaning layer.

The results given above show the following. The cleaning members of Examples 1 and 2, in which each cleaning layer had a wafer peripheral part where a wafer surface was exposed, satisfied dust-removing properties and suitability for conveyance, and the marks on these wafers could be correctly recognized. In contrast, in the cleaning member of Comparative Example 1, in which the cleaning layer did not have an exposed part such as that shown above, the mark could not be correctly recognized because the cleaning layer inhibited mark transmission.

Furthermore, in another evaluation, the two cleaning members of Examples 1 and 2 were placed/stored in a wafer case in such a manner that the wafer-surface-exposed part in each cleaning layer came into contact with the holding part of the wafer case. As a result, since the holding part was prevented from coming into contact with the cleaning layers, the resin particle generation, i.e., dusting, caused by friction by the contact could be prevented. It was thus ascertained that these cleaning members do not arouse the trouble that such particles are transferred to the semiconductor apparatus to be cleaned and thus cause particle contamination.

### Example 3

In a nitrogen stream, 30.0 g of ethylene-1,2-bistrimellitate tetracarboxylic dianhydride represented by the following chemical structural formula (hereinafter referred to as TMEG) was mixed and reacted with 65.8 g of a diamine (trade name “1300x16ATBN” manufactured by Ube Industries, Ltd.) and 15.0 g of 2,2′-bis[4-(4-aminophenoxy)phenyl]propane represented by the following chemical structural formula (hereinafter referred to as BAPP) at 120° C. in 110 g of N-methyl-2-pyrrolidone (hereinafter referred to as NMP).

[Ka-2]

### Ethylene-1,2-bistrimellitate tetracarboxylic dianhydride

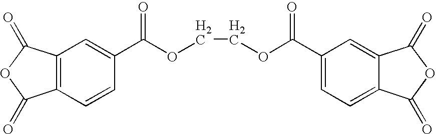

### 2,2′-Bis[4-(4-aminophenoxy)phenyl]propane

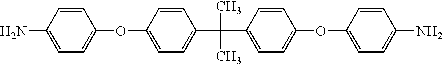

After the reaction, the reaction mixture was cooled to obtain a varnish comprising a poly(amic acid) solution. This varnish was applied to one side of a 12-inch silicon wafer with a nozzle coater. In this application, the coating nozzle was disposed at the center of the wafer and the gap between this nozzle and the wafer was regulated. Thereafter, while the varnish was being ejected from the nozzle, the wafer was rotated at a speed of 90 rpm and the nozzle was horizontally moved toward the circumference. Thus, the varnish was spirally applied so as to cause the ejected varnish to slightly overlap, i.e., so as not to leave a space between the spiral curves. The ejection from the nozzle was stopped when the nozzle had reached a position inward apart from the wafer periphery at a distance of 6 mm, whereby the application was terminated. After this coating operation, an uncoated part was left which was the whole circular area ranging inward from the wafer periphery over a distance of 6 mm.

After the application, the varnish applied was dried at 90° C. for 20 minutes and then heat-treated at 300° C. for 2 hours in a nitrogen atmosphere to form a polyimide resin film having a thickness of 30 μm.

Thus, a cleaning member for semiconductor apparatus having the structure shown in FIG. 1 was produced which was composed of a 12-inch silicon wafer and formed on one side thereof a cleaning layer comprising the polyimide resin film and in which a wafer surface was exposed in a peripheral part of the wafer.

In the step of coating with a nozzle coater in the cleaning member production described above, the varnish comprising a poly(amic acid) solution could be used while avoiding a waste of it and a considerable reduction in material loss could be attained, as different from the spin coating method in Comparative Example 2, which will be given later. In addition, since an uncoated part was formed in the coating step by the method described above, there was no need of additionally conducting a step for thereafter forming a wafer-exposed part. A cleaning member in which a wafer surface was exposed in a wafer peripheral part could be easily produced.

The cleaning member thus produced was evaluated for dust-removing properties (foreign-matter-removing properties), suitability for conveyance, and mark recognizability. In this evaluation, dust-removing properties were judged based on the count of aluminum pieces, and suitability for conveyance was judged based on whether the cleaning member was capable of being separated from a vacuum holding table with a lifting pin. Furthermore, mark recognizability was judged based on whether the mark observed through an examination with a CCD camera and image processing was correct.

The evaluation of dust-removing properties and suitability for conveyance was conducted in the following manner.

Twenty aluminum pieces 1 mm square were placed on the vacuum holding table of a semiconductor production apparatus. The cleaning member was placed thereon so that the resin-coated side thereof came into contact with these aluminum pieces. Vacuum suction (0.5 kg/cm²) was conducted for about 10 seconds, and it was attempted to separate the wafer from the table with a lifting pin. As a result, the wafer could be easily taken out. Thereafter, the number of aluminum pieces removed from the table was visually counted. As a result, the cleaning member was ascertained to show a degree of dust removal of 90% or higher in each of three counting operations.

In the evaluation of mark recognizability, a diffuser which diffused LED light was used and a CCD camera was disposed so that the shape of the mark could be caught by the CCD camera in a dark field. An image from the CCD camera was processed with a character recognition apparatus to ascertain whether the mark could be correctly recognized. As a result, the mark exposed could be correctly read as in the recognition of marks on ordinary bare wafers.

### Example 4

In 596.1 g of NMP were dissolved 66.0 g of a polyetherdiamine (XTJ-510 (D4000), manufactured by Sun Techno Chemical) and 38.0 g of p-phenylenediamine. Subsequently, 45.0 g of pyromellitic dianhydride (hereinafter abbreviated as PMDA), which is represented by the following formula, was added thereto and reacted to produce a poly(amic acid) solution.

[Ka-3]

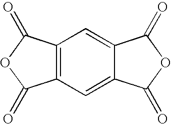

After the reaction, the reaction mixture was cooled to obtain a varnish comprising a poly(amic acid) solution. This varnish was applied to one side of a 12-inch silicon wafer in such an amount as to give a polyimide film having a thickness of 10 μm, in the same manner as in Example 1. Thus, a cleaning member having the structure shown in FIG. 1 was produced which had a cleaning layer comprising the polyimide resin film on one side of the wafer and in which a wafer surface was exposed in a peripheral part of the wafer.

This cleaning member was evaluated for dust-removing properties, suitability for conveyance, and mark recognizability in the same manners as in Example 1. As a result, the wafer could be easily taken out by wafer separation with a lifting pin. It was further ascertained that in the visual counting of the number of aluminum pieces removed from the table, the cleaning member showed a degree of dust removal of 90% or higher in each of three counting operations. Furthermore, as a result of the processing of an image from the CCD camera with a character recognition apparatus, the mark exposed could be correctly read as in the recognition of marks on ordinary bare wafers.

### Example 5

The poly(amic acid) described in Example 4 was used to produce a cleaning member having the structure shown in FIG. 1 by the method described in Example 3. This cleaning member was composed of a 12-inch silicon wafer and formed on one side thereof a cleaning layer comprising the polyimide resin film described in Example 4. In this cleaning member, a wafer surface was exposed in a peripheral part of the wafer.

This cleaning member was evaluated for dust-removing properties, suitability for conveyance, and mark recognizability in the same manners as in Example 1. As a result, the wafer could be easily taken out by wafer separation with a lifting pin. It was further ascertained that in the visual counting of the number of aluminum pieces removed from the table, the cleaning member showed a degree of dust removal of 90% or higher in each of three counting operations. Furthermore, as a result of the processing of an image from the CCD camera with a character recognition apparatus, the mark exposed could be correctly read as in the recognition of marks on ordinary bare wafers.

### Comparative Example 2

The varnish comprising a poly(amic acid) solution obtained in Example 3 was applied to one side of a 12-inch silicon wafer with a spin coater. In this application, the rotation speed was increased to 1,000 rpm at an acceleration of 10,000 rpm/sec, which took about 0.1 second. Thereafter, that rotation speed was maintained until 0.5 seconds had passed since the initiation of the rotation. The rotation speed was then reduced to 500 rpm at a decelation of 100 rpm/sec, and this rotation speed was maintained for 40 seconds. Subsequently, the nozzle position was automatically controlled, and NMP was dropped onto the protruding part which had formed along the periphery to thereby conduct edge rinsing and flattening.

After the application, the varnish applied was dried at 90° C. for 20 minutes and then heat-treated at 300° C. for 2 hours in a nitrogen atmosphere to form a polyimide resin film having a thickness of 10 μm.

Thus, a cleaning member for semiconductor apparatus was produced which was composed of a 12-inch silicon wafer and, formed over the whole surface of one side thereof, a cleaning layer comprising the polyimide resin film, i.e., which had no wafer peripheral part where a wafer surface was exposed.

This cleaning member was evaluated for dust-removing properties, suitability for conveyance, and mark recognizability in the same manners as in Example 3. As a result, the wafer could be easily taken out by wafer separation with a lifting pin. It was further ascertained that in the visual counting of the number of aluminum pieces removed from the table, the cleaning member showed a degree of dust removal of 90% or higher in each of three counting operations. However, as a result of the processing of an image from the CCD camera with a character recognition apparatus, the mark underlying the cleaning layer could not be correctly recognized because of the impaired transparency due to the overlying cleaning layer.

The results given above show the following. The cleaning member of Example 1, in which the cleaning layer had a wafer peripheral part where a wafer surface was exposed, satisfied dust-removing properties and suitability for conveyance, and the mark on the wafer could be correctly recognized. In contrast, in the cleaning member of Comparative Example 2, in which the cleaning layer did not have an exposed part such as that shown above, the mark could not be correctly recognized because the cleaning layer inhibited mark transmission.

Furthermore, in another evaluation, the cleaning members of Examples 3 and 4 were placed/stored in a wafer case in such a manner that the wafer-surface-exposed part in each cleaning layer came into contact with the holding part of the wafer case. As a result, since the holding part was prevented from coming into contact with the cleaning layers, the resin particle generation, i.e., dusting, caused by friction by the contact could be prevented. It was thus ascertained that these cleaning members do not arouse the trouble that such particles are transferred to the semiconductor apparatus to be cleaned and thus cause particle contamination.

Furthermore, the cleaning member of the Comparative Example was placed/stored in a wafer case. As a result, the holding part of the wafer case came into contact with the cleaning layer. Because of this, there is a possibility that particles attributable to the cleaning layer might generate upon contact friction. There is hence a fear that this cleaning member may contaminate the semiconductor apparatus to be cleaned.

While the invention has been described in detail and with reference to specific embodiments thereof, it will be apparent to one skilled in the art that various changes and modifications can be made therein without departing from the spirit and scope thereof.

This application is based on a Japanese patent application filed on Mar. 8, 2004 (Application No. 2004-63858) and another Japanese patent application filed on Mar. 8, 2004 (Application No. 2004-63859), the entire contents thereof being herein incorporated by reference.

### INDUSTRIAL APPLICABILITY

According to the invention, a cleaning layer is constituted of a specific resinous coating layer made of a heat-resistant resin formed by thermally curing a poly(amic acid) and part of the coating layer has been removed to form a part where a wafer surface is exposed. Because of this, a cleaning member can be provided in which a mark for lot management formed on the wafer has improved recognizability and which does not cause particle generation, i.e., dusting, when taken out of a wafer case, and can be used to stably conduct the cleaning of the wafer fixing table and conveying system of a semiconductor apparatus.

Furthermore, according to the invention, a specific resinous coating layer made of a heat-resistant resin formed by thermally curing a poly(amic acid) is formed as a cleaning layer by a specific technique in which a varnish is spirally applied to a wafer. Because of this, the material loss accompanying the spin coating method is eliminated and the resin material can be utilized while avoiding a waste of it. In addition, since the cleaning layer comprising this resinous coating layer is formed so as to have a part where a wafer surface is exposed, a cleaning member can be provided in which a mark for lot management formed on the wafer has improved visibility and which does not cause particle generation, i.e., dusting, when taken out of a wafer case, and can be used to stably conduct the cleaning of the wafer fixing table and conveying system of a semiconductor apparatus.

Moreover, since the cleaning layer described above which has a part where a wafer surface is exposed is formed by a method in which the coating area in wafer coating is regulated so as to leave an uncoated part, the formation of an exposed part is easier than in other methods, e.g., the method in which the whole wafer surface is coated and part of the coating is thereafter dissolved away to form a part where a wafer surface is exposed. Thus, a process for cleaning member production which is more desirable from the standpoint of steps can be provided.

1. A cleaning member for semiconductor apparatus, which comprises a wafer and formed on at least one side thereof a cleaning layer made of a heat-resistant resin formed by thermally curing a poly(amic acid), and wherein the cleaning layer has a part wherein a wafer surface is exposed.

2. The cleaning member for semiconductor apparatus according to claim 1, wherein that part in the cleaning layer in which a wafer surface is exposed is a part wherein the cleaning layer has been removed throughout the whole circular area having a given width ranging from the peripheral edge of the wafer toward the center thereof.

3. A process for producing a cleaning member for semiconductor apparatus, characterized by producing the cleaning member for semiconductor apparatus of claim 1 or 2 through:
a first step in which a varnish comprising a poly(amic acid) solution is produced;
a second step in which the varnish is applied to a wafer surface;
a third step in which the varnish applied on the wafer is dried;
a fourth step in which part of the varnish on the wafer is partly removed by dropping a solvent thereonto to thereby form a part wherein a wafer surface is exposed; and
a fifth step in which the residual coating film is cured at a temperature of 200° C. or higher.

4. A method of cleaning a semiconductor apparatus, characterized by conveying the cleaning member for semiconductor apparatus of claim 1 or 2 in the semiconductor apparatus to thereby remove foreign matters adherent to inner parts of the semiconductor apparatus.

5. A process for producing a cleaning member for semiconductor apparatus, which comprises a wafer and formed on at least one side thereof a cleaning layer made of a heat-resistant resin formed by thermally curing a poly(amic acid), and wherein the cleaning layer has a part where a wafer surface is exposed, characterized by comprising:
(1) a step in which a varnish comprising a poly(amic acid) solution is obtained,
(2) a step in which the varnish is applied to a wafer,
(3) a step in which the varnish applied on the wafer is dried, and
(4) a step in which the coating film after the drying is cured at a temperature of 200° C. or higher, wherein the step (2) comprises horizontally and rotatably fixing the wafer to the top of a table, disposing a horizontally movable coating nozzle over the wafer, ejecting the varnish from the nozzle while rotating the wafer and horizontally moving the nozzle to thereby spirally apply the varnish to the wafer so as not to leave a space between the spiral curves, and regulating that area in the wafer surface which is to be thus coated to thereby leave an uncoated part wherein a wafer surface is exposed.

6. The process for producing a cleaning member for semiconductor apparatus of claim 5, wherein the uncoated part wherein a wafer surface is exposed is the whole circular area having a given width ranging from the peripheral edge of the wafer toward the center thereof.
